(19) United States
(12) Patent Application Publication
(10) Pub. No.: US 2006/0082802 A1
(43) Pub. Date: Apr. 20, 2006

(54) Printing apparatus, setting method in the apparatus, and program

(75) Inventor: Tomoyuki Furuya, Ohta-ku (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/249,969

(22) Filed: Oct. 13, 2005

(30) Foreign Application Priority Data
Oct. 14, 2004 (JP) 2004-300550

(51) Int. Cl. G06F 3/12

(52) U.S. Cl. 358/1.13

(57) ABSTRACT

A printing apparatus includes a receiving unit configured to receive print data including setting data; a determining unit configured to determine whether a conflict of functions occurs in the setting data received by the receiving unit; and an output unit configured to output a disabled function and directions for enabling the disabled function if the determining unit determines that a conflict of the functions occurs in the setting data.

### BACKGROUND OF THE INVENTION

1. Field of the Invention

The present invention relates to a printing apparatus configured to perform printing based on settings, a setting method in the printing apparatus, and a program.

2. Description of the Related Art

Known printing apparatuses determine functions to be used in accordance with setting data to perform printing. If the functions specified in the setting data cannot coexist with each other or if the printing apparatuses do not have the specified functions, the printer drivers prioritize the functions specified in the setting data to enable only higher priority functions. Alternatively, error handling in which the settings of unprocessable functions, for example, functions that cannot coexist with the function already enabled, are ignored is adopted.

For example, in an example of the above processing employed in print servers, it is possible to efficiently hold job tickets without contradiction, in which job tickets actual instructions about devices do not correspond to the final products which users intend to use. A technology relating to a print instruction device capable of processing such job tickets is disclosed in Japanese Patent Laid-Open No. 2004-240849.

However, direct print systems differ from printing systems that generate print data with the printer drivers completely recognizing the functions of the printing apparatuses for every apparatus type. In addition, it is difficult for the setting-data generation applications in the direct print systems to completely recognize all the functions of the printing apparatuses.

Particularly, when new types of the printing apparatuses are released, the printer drivers can be supplied with the main bodies for distribution while the setting-data generation application in the direct print systems are not necessarily supplied from companies which have released the printing apparatuses. Accordingly, the information concerning, for example, detailed functions of the printing apparatuses are insufficient for the setting-data generation application to completely recognize all the functions of the printing apparatuses.

Problems about the setting data are caused when the direct print systems have multiple functions, for example, stapler and punch, which cannot coexist with each other (hereinafter referred to as a conflict) and when different conditions causing the conflict are set in different types of the printing apparatuses.

Specifically, in the printing systems using the printer drivers, the functions causing the conflict are grayed out (are made unselectable states) and the messages indicating the occurrence of the conflict are displayed in the user interfaces with which users select functions. In contrast, in the direct print systems using the setting-data generation applications that do not recognize detailed conditions of the conflict in the printing apparatuses, the conflict of the functions specified in the setting data is apt to occur.

As described above, the printing apparatuses that use known direct print technologies disable the functions having the conflict as the error handling for the setting data having the conflict to perform the printing. As a result, there is a problem in that users who have obtained the print results with printing apparatuses are not aware that the printing was performed with some functions being disabled. Even when the users are aware of the disabled functions, there are cases where the users do not know how to enable the disabled functions. Furthermore, in such cases, appropriate selection of the functions in consideration of the priority of the functions are not necessarily performed in the printing apparatuses and, therefore, print outputs different from the print outputs expected by the users may be undesirably produced.

### SUMMARY OF THE INVENTION

The present invention is directed to a printing apparatus, a setting method in the printing apparatus, and a program, which are capable of performing appropriate and user-friendly processing for unprocessable settings, such as conflicts, in direct print.

According to an embodiment of the present invention, a printing apparatus includes a receiving unit configured to receive print data including setting data; a determining unit configured to determine whether a conflict of functions occurs in the setting data received by the receiving unit; and an output unit configured to output a disabled function and directions for enabling the disabled function if the determining unit determines that a conflict of the functions occurs in the setting data.

According to another embodiment of the present invention, a printing apparatus includes a receiving unit configured to receive print data including setting data; a determining unit configured to determine whether a conflict of functions occurs in the setting data received by the receiving unit; and a reset unit configured to reset the setting data if the determining unit determines that a conflict of the functions occurs in the setting data.

Further features and aspects of the present invention will become apparent from the following description of exemplary embodiments with reference to the attached drawings.

### BRIEF DESCRIPTION OF THE DRAWINGS

FIG. 1 schematically shows an example of the architecture of a printing system which includes a printing apparatus (an image forming apparatus), according to an embodiment of the present invention.

FIG. 2 shows the functional architecture of a host device and a printing device shown in FIG. 1, according to a first exemplary embodiment of the present invention.

FIG. 3 shows an example indicating how the functions in setting data are divided into enabled function data and disabled function data and are registered.

FIG. 4 shows examples of print results of disabled-function print data when a disabled function exists, according to an aspect of the present invention.

FIG. 5 is a flowchart showing an exemplary setting data process in the printing device in FIG. 2.

FIG. 6 is a flowchart showing an example of a setting data process in a printing device according to a modification of the first exemplary embodiment of the present invention.

FIG. 7 shows the functional structure of the host device and the printing device shown in FIG. 1, according to a second exemplary embodiment of the present invention.

FIG. 8 shows an example of determination and registration of the setting data in a setting-data determiner-register.

FIG. 9 shows an example of a print result of the disabled-function print data when the disabled function exists.

FIG. 10 shows examples of disabled-function display data displayed in a user interface unit when the identification of disabled-function print data is input in the printing device.

FIG. 11 is a flowchart showing an exemplary process from a time when the printing device receives the print data to a time when the printing device outputs the disabled-function print data.

FIG. 12 is a flowchart showing an exemplary process from a time when a user who has obtained the disabled-function print data sets the functions in the printing device to a time when a final print is output.

FIG. 13 shows the functional architecture of the host device and the printing device shown in FIG. 1, according to a third exemplary embodiment of the present invention.

FIG. 14 shows examples of disabled-function reset screens displayed in a display device in the host device by a disabled-function reset application, according to the third exemplary embodiment of the present invention.

FIG. 15A is a flowchart showing an exemplary setting data process in a printing system including the host device and the printing device shown in FIG. 13.

FIG. 15B is a flowchart showing in detail an exemplary function reset process in Step S15-14 in FIG. 15A.

FIG. 16 shows an example of the structure of normal print data.

FIGS. 17A and 17B show examples of processing in known setting-data generation applications.

### DESCRIPTION OF THE EMBODIMENTS

### Print Data & Setting Data Generation Background

Printing apparatuses have advanced in function in recent years to not only simply print drawing data but also have various functions, such as, two-sided printing, stapler, punch, and layout change. Specification of the functions that are used are supplied to the printing apparatuses by using setting data (also referred to as a job ticket) which is different from the drawing data. The drawing data and the setting data are collectively referred to as print data. FIG. 16 shows an example of the structure of normal print data.

The setting data is generally generated by the printer drivers in host devices corresponding to the printing apparatuses. The host apparatuses are connected to the printing apparatuses via networks and are capable of communication with the printing apparatuses. Specifically, the setting data is generated in accordance with functions specified by users who operate the user interfaces in the printer drivers, displayed in the host apparatuses.

In addition to the printing systems, described above, which generate the print data with the printer drivers, direct print systems directly printing application documents and/or bitmap data are also provided.

In such direct print systems, the application documents and/or the bitmap data are directly used as the drawing data. When functions of the printing apparatuses are used, the setting data is generated by, for example, setting-data generation applications. Alternatively, instead of using the setting-data generation applications, users directly operate the user interfaces in the printing apparatuses to set the functions that are used.

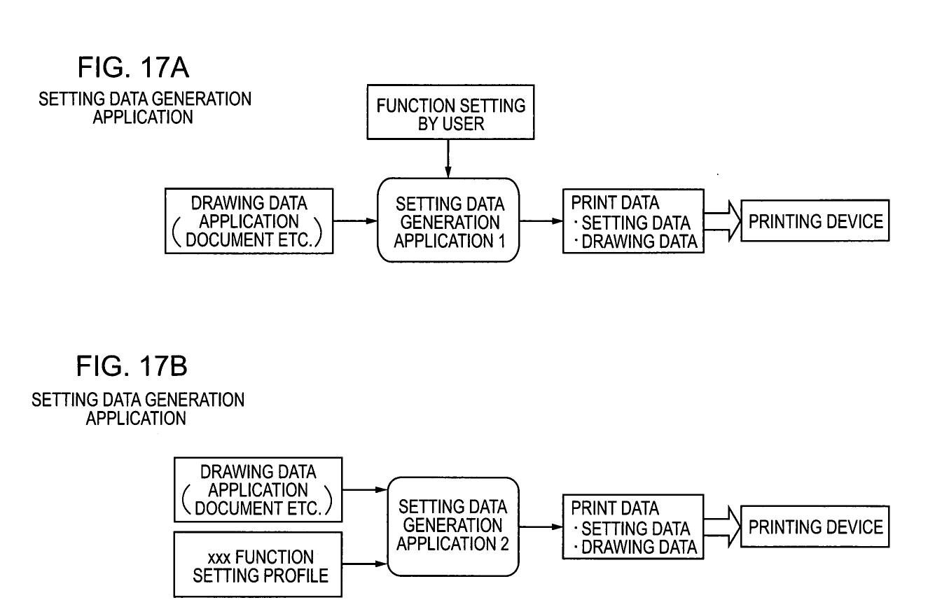

An example of the above setting-data generation applications is shown in FIG. 17A. Here, an application recognizing functions, etc. of the printing apparatus presents the functions of the printing apparatus to a user who sets the values of the functions to generate the setting data in accordance with the values set by the user. In another example of the setting-data generation application shown in FIG. 17B, the used functions are stored as profiles in advance and the setting data is generated from a profile selected by a user.

### Exemplary Embodiments of the Present Invention

Embodiments of the present invention will now be described below with reference to the attached drawings.

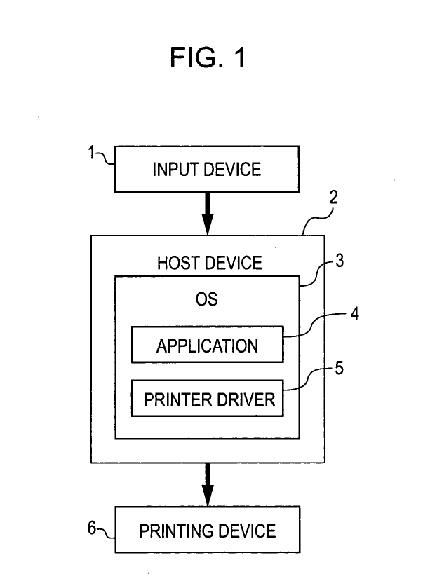

FIG. 1 schematically shows an example of an architecture of a printing system having a printing apparatus (an image forming apparatus), according to an embodiment of the present invention. Instructions are supplied from an input device 1 to a host device 2 and print data (see FIG. 16) is supplied to a printing device 6 in response to the instructions.

Still referring to FIG. 1, the input device 1 may be, for example, a mouse or a keyboard adapted to supply an input signal in accordance with a user operation to the host device 2. The host device 2 may be, for example, a computer terminal having an operating system (OS) 3 installed therein. An application 4 and a printer driver 5 run on the OS 3 in the host device 2. The printer driver 5 supports the printing device 6. The printing device 6 receives a print job from the host device 2 to perform printing. The printing device 6 may include a direct print function of processing a print job (print data) supplied from the application 4, in addition to a print job (print data) supplied from the printer driver 5.

An exemplary outline of the operation of the printing system shown in FIG. 1 will now be described. A user operates the input device 1 to issue an instruction in order to execute the application 4 or the printer driver 5 running on the OS 3 in the host device 2. The host device 2 transmits to the printing device 6 the print data that is generated. The printing device 6 receives the print data to perform the printing.

Exemplary interfaces for connecting the input device 1 to the host device 2 and connecting the host device 2 to the printing device 6, may include, but is not limited to, a Centronics interface, an infrared data communication interface, a radio communication interface, a universal serial bus (USB) interface, an interface compliant with the IEEE1394 standard, or the like. Furthermore, the input device 1 may be connected to the host device 2 over a network and the host device 2 may also be connected to the printing device 6 over a network, as long as the input device 1 is capable of communication with the host device 2 and the host device 2 is capable of communication with the printing device 6. The network connection may be realized over any communication network, such as, but not limited to, a local area network (LAN), wireless cellular network and/or the Internet. The host device 2 may be a standalone personal computer (PC) or may be a server PC in a client-server system. When the host device 2 is a server PC, the input device 1 is, for example, a client PC.

### First Exemplary Embodiment

As a first exemplary embodiment in a printing system having the architecture shown in FIG. 1, an example of the functional architecture of the host device 2 and the printing device 6 will now be described.

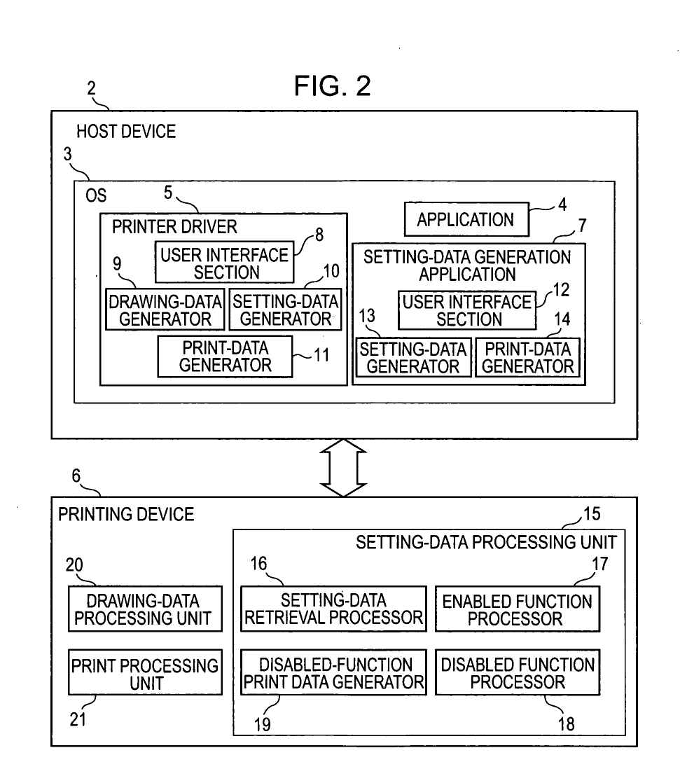

FIG. 2 shows a functional structure of the host device 2 and the printing device 6 shown in FIG. 1, according to the first embodiment. Referring to FIG. 2, the host device 2 generating the print data includes the OS 3 controlling the host device 2. The application 4, the printer driver 5, and a setting-data generation application 7 run on the OS 3.

The printer driver 5 includes a user interface section 8, a drawing-data generator 9, a setting-data generator 10, and a print-data generator 11. The drawing-data generator 9 generates drawing data appropriate for the printing device 6 from the data output from the application 4. The user interface section 8 provides a graphical user interface (GUI) for setting functions that can be set in the printing device 6 and a user sets the functions with the GUI. The setting-data generator 10 generates setting data appropriate for the printing device 6 in accordance with the function settings specified by the user with the user interface section 8 in advance. The print-data generator 11 generates print data based on the drawing data generated by the drawing-data generator 9 and the setting data generated by the setting-data generator 10.

In the printing system according to the first embodiment, the process flows in the generation of the print data is roughly divided into two processes. In one process, the printer driver 5 generates the print data appropriate for the printing device 6 from the data output from the application 4 and outputs the generated print data. In the other process, the host device 2 directly outputs the data output from the application 4 or a data file created in advance as the drawing data or the print data for the printing device 6. The latter process is called direct print.

With direct print, the data output from the application 4 or the data file created in advance can be directly used as the print data that is printed in the printing device 6. However, with this operation, even when the printing device 6 is provided with various functions, the functions cannot be used. Accordingly, in direct print, the functions which the user wants to use can be specified in the setting-data generation application 7.

The setting-data generation application 7 includes a user interface section 12, a setting-data generator 13, and a print-data generator 14. The user interface section 12 provides, for example, a graphical user interface (GUI) for setting functions that can be set in the printing device 6 and the user sets the functions with the GUI. The setting-data generator 13 generates setting data appropriate for the printing device 6 in accordance with the function settings specified by the user with the user interface section 12. The print-data generator 14 generates print data based on the data or the data file output from the application 4 and the setting data.

However, the setting-data generation application 7 according to the first embodiment may not completely recognize the functions of the printing device 6, unlike the printer driver 5 supplied with the printing device 6 for distribution. Hence, the setting data generated in the setting-data generation application 7 may include function settings inappropriate for the printing device 6. In other words, a conflict (function conflict) may occur in the direct print in the printing device 6.

An exemplary method of processing the setting data, according to the first embodiment, performs appropriate processing for the inappropriate function settings, including the conflict in the direct print, to achieve a desired effect. Specifically, the function of processing the setting data, according to the first embodiment, is provided in the printing device 6 and the function achieves the desired effect when the setting-data generation application 7 supplies inappropriate setting data to the printing device 6.

The functional structure of the printing device 6 will now be described. As shown in FIG. 2, the printing device 6 includes three processing units: a setting-data processing unit 15, a drawing-data processing unit 20, and a print processing unit 21. The printing device 6 has a receiving function of receiving the print data (print job) from the host device 2 and a dividing function of dividing the received print data into the drawing data and the setting data. The setting data resulting from the division in the printing device 6 is processed in the setting-data processing unit 15.

The setting-data processing unit 15 includes a setting-data retrieval processor 16, an enabled function processor 17, a disabled function processor 18, and a disabled-function print data generator 19. The setting-data retrieval processor 16 determines whether the functions specified in the setting data are available in order of priority. The enabled function processor 17 sets the function determined as available by the setting-data retrieval processor 16 as an enabled function. The disabled function processor 18 sets, as a disabled function, the function determined as a function that cannot coexist with the function set by the enabled function processor 17 and the function determined as a function that is unprocessable in the printing device 6 by the setting-data retrieval processor 16.

Specifically, the enabled function processor 17 registers the function determined as available in enabled function data. The disabled function processor 18 registers the function determined as unavailable in disabled function data. The enabled function data and the disabled function data are temporarily stored in the setting-data processing unit 15. The processing in the setting-data retrieval processor 16, the enabled function processor 17, and the disabled function processor 18, described above, is repeated until the processing is completed for all the functions in the setting data.

After all the functions in the setting data have been processed, the disabled-function print data generator 19 generates disabled-function print data indicating that the disabled function exists when any function is registered in the disabled function data.

The drawing-data processing unit 20 performs drawing data processing, such as bit-mapping, for the drawing data in the print data received by the printing device 6 based on the enabled function data. The print processing unit 21 performs printing and finishing according to the functions set in the enabled function data based on the drawing data bit-mapped by the drawing-data processing unit 20 and the enabled function data. The print processing unit 21 prints any disabled-function print data. The disabled-function print data is the print data for presenting the information concerning the disabled function to the user. Examples of the print results will be described below.

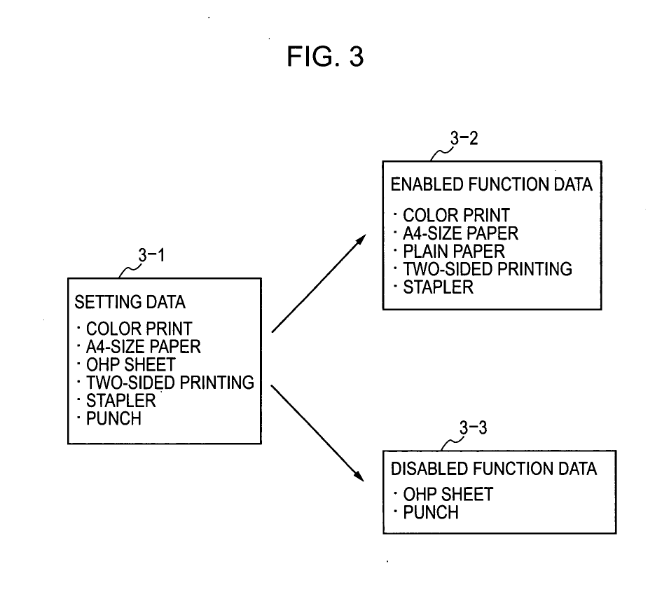

FIG. 3 shows an example indicating how the functions in the setting data are divided into the enabled function data and the disabled function data and are registered. Referring to FIG. 3, reference numeral 3-1 denotes setting data having “Color print”, “A4-size paper”, “Overhead projector (OHP) sheet”, “Two-sided printing”, “Stapler”, and “Punch” set therein as the functions. Since the “Stapler” cannot coexist with the “Punch” and the “OHP sheet” cannot coexist with the “Two-sided printing” in the printing device 6, two conflicts occur.

The setting-data processing unit 15 performs the following processing based on the setting data 3-1 to generate enabled function data 3-2 and disabled function data 3-3. It is assumed in the setting-data processing unit 15 that the “Stapler” has higher priority over the “Punch” and the “Two-sided printing” has higher priority over the “OHP sheet”. Accordingly, the setting-data retrieval processor 16 determines that the “Stapler” is enabled and the “Punch” is disabled and that the “Two-sided printing” is enabled and the “OHP sheet” is disabled. The priority and the conflict rules are not limited to ones according to the first embodiment. The information concerning the conflict (conflict rule) in the setting-data processing unit 15 and the information concerning the priority of the functions may be varied for every type of the printing device 6. According to the first embodiment, higher priorities are given to the functions which most users probably expect based on their experiment or performance.

The disabled function processor 18 registers the “OHP sheet” and the “Punching”, which have the conflicts and have lower priorities, in the disabled function data 3-3 in accordance with the above determination in the setting-data retrieval processor 16. The enabled function processor 17 registers, in the enabled function data 3-2, the “Color print” and “A4-size paper” irrelevant to the conflict, “Plain paper” set as default paper, instead of the disabled “OHP sheet”, and the “Stapler” and the “Two-sided printing” having higher priorities.

The data formats of the enabled function data 3-2 and the disabled function data 3-3 in FIG. 3 may be similar to or may be different from that of the setting data 3-1 used in the communication between the host device 2 and the printing device 6. In other words, since the enabled function data 3-2 and the disabled function data 3-3 are used only in the printing device 6, any format may be used.

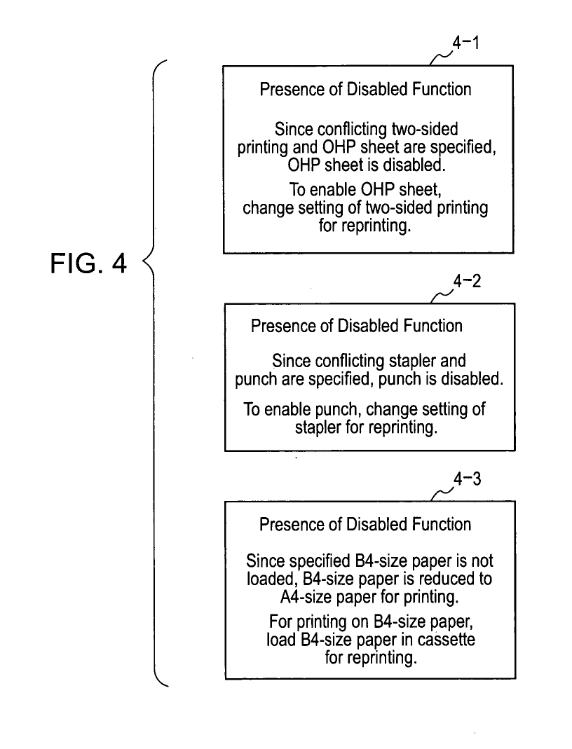

FIG. 4 shows examples of print results of the disabled-function print data when the disabled function exists. A print result 4-1 is produced in a case where a conflict occurs between the “two-sided printing” and the “OHP sheet”. The print result 4-1 shows that the disabled functions exist, the information concerning the conflicting functions, that the “OHP sheet” is disabled, and that the setting of the “Two-sided printing” should be changed in order to enable the “OHP sheet”.

A print result 4-2 is produced in a case where a conflict occurs between the “stapler and the “Punch”. The print result shows that the disabled functions exist, the information concerning the conflicting functions, that the “Punch” is disabled, and that the setting of the “Stapler” should be changed in order to enable the “Punch”.

A print result 4-3 is produced in a case where the B4-size paper is not loaded in the paper feed tray of the printing device 6 but the B4-size paper is specified in the setting data. The print result 4-3 shows that the disabled functions exist, that a reduction from the B4-size paper to the A4-size paper has been performed for printing because the specification of the “B4-size paper” is disabled, and that the B4-size paper should be loaded in the paper feed cassette in order to perform the printing on the B4-size paper.

The print results 4-1 to 4-3 may also include other forms of information including a job number identifying the print job (print data), a printer ID identifying the printing device 6, a document name (a file name in the application 4), and the date and time when the print data was received.

As shown in the print results 4-1 to 4-3, the printing device 6 according to the first embodiment selects the conflicting functions in order of priority if any conflict occurs. If a disabled function is specified, the printing device 6 ignores the setting of the disabled function or changes the setting to an enabled function and performs the printing based on the setting of the enabled function. The printing device 6 prints, for example, the information concerning the disabled function and the information used for enabling the disabled function.

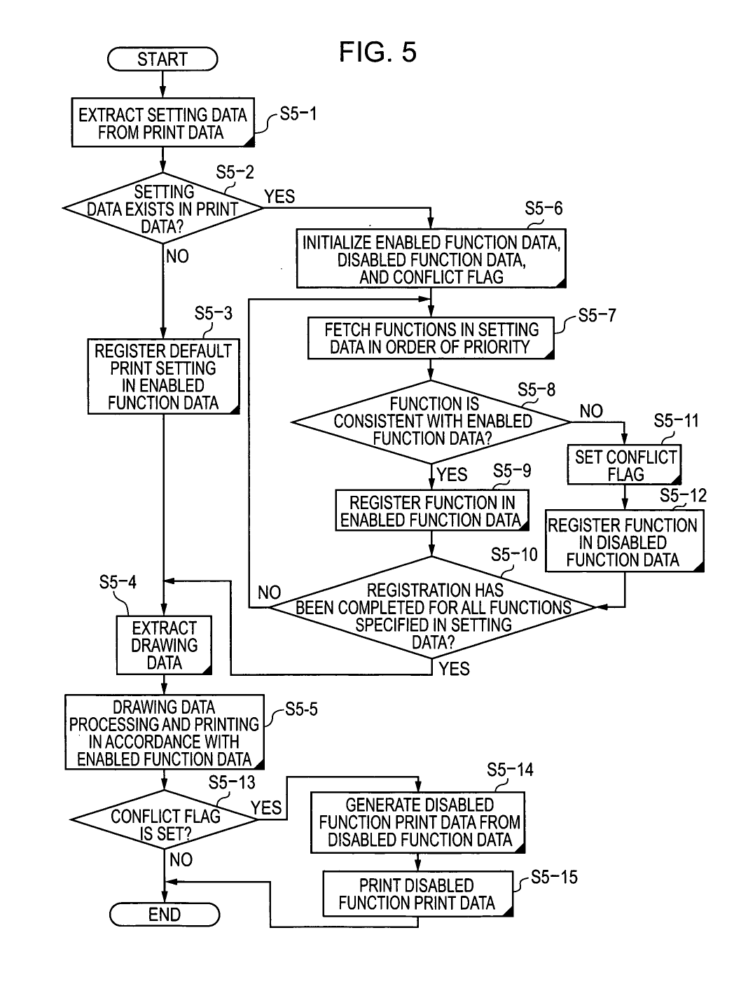

FIG. 5 is a flowchart showing an exemplary setting data process in the printing device 6 in FIG. 2. The method of processing the setting data according to the first embodiment will now be described with reference to FIG. 5.

After the print data is supplied from the host device 2 to the printing device 6, in Step S5-1, the setting-data processing unit 15 extracts the setting data from the print data. In Step S5-2, the setting-data processing unit 15 determines whether the setting data exists in the print data. If the setting data does not exist in the print data in the direct print (the determination is negative in Step S5-2), then in Step S5-3, the enabled function processor 17 registers the default print setting in the enabled function data.

If the setting data exists in the print data (the determination is affirmative in Step S5-2), then in Step S5-6, the setting-data processing unit 15 initializes the enabled function data, the disabled function data, and a conflict flag. The conflict flag is set when any disabled function exists.

In Step S5-7, the setting-data retrieval processor 16 fetches each of the functions specified in the setting data in order of priority. In Step S5-8, the setting-data retrieval processor 16 determines whether the fetched function can coexist with all the functions already registered in the enabled function data. If the setting-data retrieval processor 16 determines that the function can coexist with all the functions in the enabled function data (the determination is affirmative in Step S5-8), then in Step S5-9, the enabled function processor 17 registers the function in the enabled function data. If the setting-data retrieval processor 16 determines that the function cannot coexist with all the functions in the enabled function data (the determination is negative in Step S5-8), then in Step S5-11, the disabled function processor 18 sets a conflict flag indicating the disabled function exists. In Step S5-12, the disabled function processor 18 registers the function in the disabled function data. In Step S5-8, the setting-data retrieval processor 16 also determines whether the function fetched in Step S5-7 is processable in the printing device 6. If the setting-data retrieval processor 16 determines that the function is unprocessable, the setting-data retrieval processor 16 registers the function in the disabled function data.

In Step S5-10, the setting-data processing unit 15 determines whether the registration has been completed for all the functions specified in the setting data. If the setting-data processing unit 15 determines that the registration has not been completed for all the functions in the setting data (the determination is negative in Step S5-10), the process goes back to Step S5-7. The steps from S5-7 to S5-9 or the steps S5-7, S5-8, S5-11, and S5-12 are repeated until all the functions specified in the setting data have been registered in the enabled function data or the disabled function data.

If the setting-data processing unit 15 determines that the registration has been completed for all the functions specified in the setting data (the determination is affirmative in Step S5-10), then in Step S5-4, the host device 20 extracts the drawing data from the print data. Or, after the default print setting is registered in the enabled function data in Step S5-3 because the setting data does not exist, then in Step S5-4, the drawing-data processing unit 20 extracts the drawing data from the print data. In Step S5-5, the drawing-data processing unit 20 processes the extracted drawing data in accordance with the enabled function data and, then, the print processing unit 21 performs the printing in accordance with the enabled function data based on the drawing data processed by the drawing-data processing unit 20.

In Step S5-13, the setting-data processing unit 15 determines whether the conflict flag indicating the disabled function exists is set. If the setting-data processing unit 15 determines that the conflict flag is not set, the setting data process terminates. If the setting-data processing unit 15 determines that the conflict flag is set, in Step S5-14, the disabled-function print data generator 19 generates disabled-function print data from the disabled function data. In Step S5-15, the print processing unit 21 prints the generated disabled-function print data and, then, the setting data process terminates.

As described above with reference to FIG. 5, the printing device 6 according to the first embodiment sets priority for the conflicting setting data (job ticket) in the printing in the direct print to print what most users probably expect. In addition, the printing device 6 presents the print logs, such as the print results 4-1 to 4-3 in FIG. 4, to the user to indicate that the disabled function exists and to present instructions for providing desired outputs. Accordingly, the printing device 6 can suggest a method of achieving the desired outputs to the users who did not obtain the expected outputs. In other words, the printing device 6, according to the first embodiment, can perform appropriate and user-friendly processing for unprocessable settings, such as conflicts, in direct print.

### Alternative Variant of First Embodiment

In the process according to the first embodiment, shown in FIG. 5, if a conflict occurs, the printing is performed with priority being set for the conflicting setting data and, then, the disabled-function print data is printed. In contrast, according to an alternative variant of the first embodiment, the disabled-function print data is printed first if a conflict occurs. When any instruction is issued from a user who viewed the print output of the disabled-function print data, the printing is performed with functions having higher priorities being set.

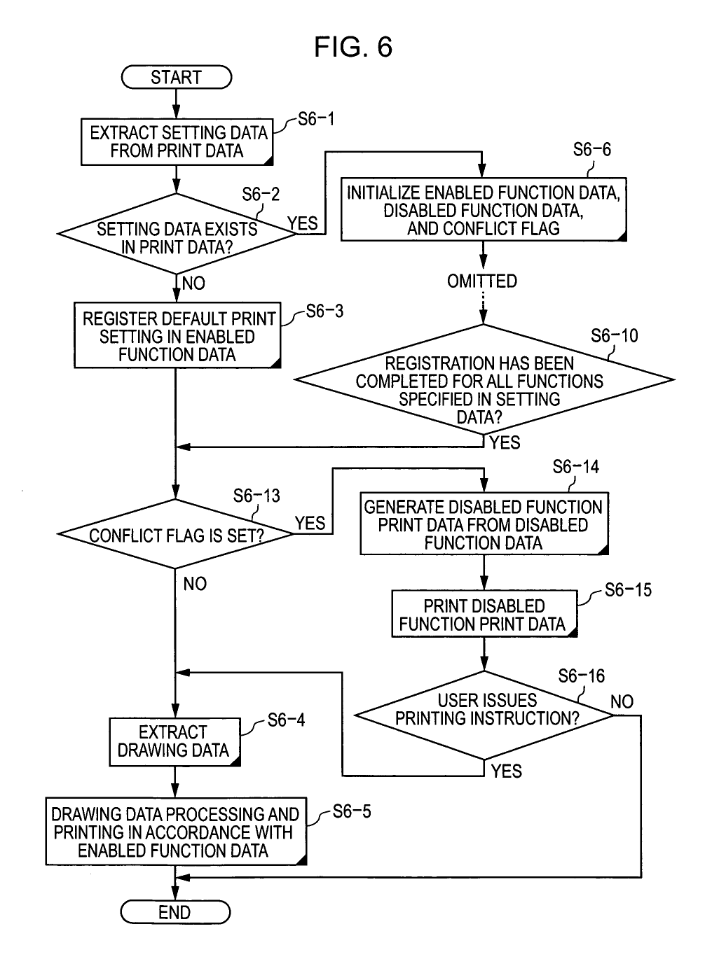

FIG. 6 is a flowchart showing an example of the setting data process in the printing device 6 according to the alternative variant of the first embodiment. The steps S6-1 to S6-3 and S6-6 to S6-10 in FIG. 6 are similar to the process steps S5-1 to S5-3 and S5-6 to S5-12 shown in FIG. 5, therefore, description is omitted herein. It is further noted that the content of steps S6-4 and S6-5 and steps S6-13 to S6-15 in FIG. 6 is similar to that of S5-4 and S5-5 and S5-13 to S5-15 in FIG. 5, except the aforementioned steps in FIG. 6 are performed at a time different from that in FIG. 5.

Now referring to FIG. 6, if the setting-data processing unit 15 determines that the registration has been performed for all the functions specified in the setting data (the determination is affirmative in Step S6-10), then in Step S6-13, the setting-data processing unit 15 determines whether a conflict flag is set. Or, after the default print setting is registered in the enabled function data in Step S6-3 because the setting data does not exist, then in Step S6-13, the setting-data processing unit 15 determines whether a conflict flag is set. If the setting-data processing unit 15 determines that a conflict flag is not set, then in Step S6-4, the drawing-data processing unit 20 extracts the drawing data. In Step S6-5, the drawing-data processing unit 20 processes the extracted drawing data and, then, the print processing unit 21 performs the printing.

If the setting-data processing unit 15 determines in Step S6-13 that a conflict flag is set, then in Step S6-14, the disabled-function print data generator 19 generates disabled-function print data from the disabled function data. In Step S6-15, the print processing unit 21 prints the disabled-function print data. At this time, for example, the print result 4-1, 4-2, and/or 4-3 in FIG. 4 are output from the printing device 6. If the user who got the print output from the printing device 6 and viewed the print result of the disabled-function print data confirms that desired enabled functions are set in the printing device 6, the user issues a print instruction to the printing device 6. The printing device 6 determines that the print instruction is issued (the determination is affirmative in Step S6-16) and proceeds to Step S6-4.

An example of how the user issues the print instruction to the printing device 6 will now be described. For example, the printing device 6 is provided with a display device (such as a liquid crystal panel) used for displaying a list of job numbers of the received print jobs (print data), a selection button used for selecting a job number, and an execution button used for executing the printing for the selected job number. The job numbers are also shown in the print results 4-1 to 4-3. When the user views the print results 4-1 to 4-3 and confirms that the functions are desirably set, the user selects a job number with the selection button and presses the execution button to issue a print instruction to the printing device 6. Accordingly, with regard to the alternative variant of the first embodiment, the printing device 6 holds the print data until the print instruction is issued.

### Second Exemplary Embodiment

A second exemplary embodiment of the printing system having the architecture shown in FIG. 1 will now be described. Specifically, an example of the functional architecture of the printing device 6 capable of suspending the printing process while holding the print job, if a conflict occurs, to allow a user to reset the functions of the printing device 6 will now be described.

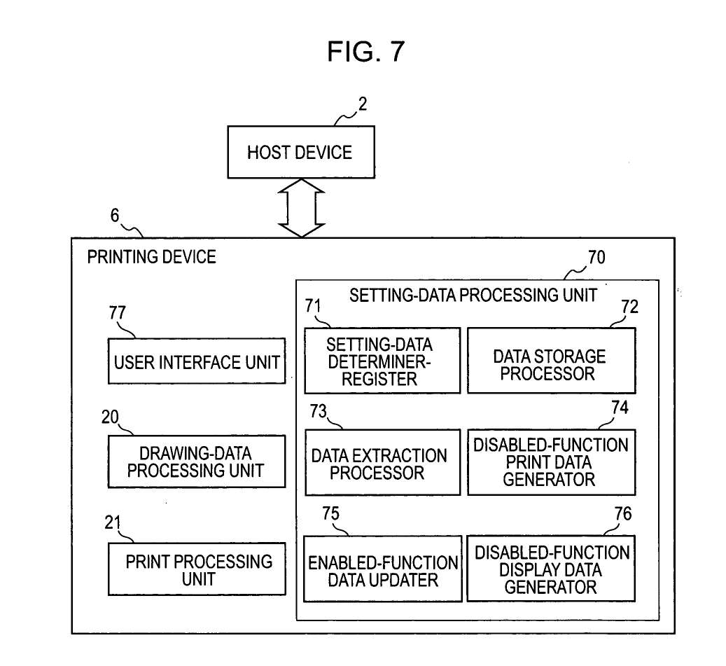

FIG. 7 shows the functional architecture of the host device 2 and the printing device 6 shown in FIG. 1, according to the second exemplary embodiment of the present invention. Since the host device 2 in FIG. 7 has a similar architecture as the host device 2 in FIG. 2, a description of the host device 2 has been omitted. Furthermore, the same reference numerals are used in the printing device 6 in FIG. 7 to identify the same functional blocks in the printing device 6 shown in FIG. 2. A description of these functional blocks is also omitted.

Referring now to FIG. 7, the printing device 6 according to the second exemplary embodiment includes four processing units: a setting-data processing unit 70, a user interface unit 77, a drawing-data processing unit 20, and a print processing unit 21. The printing device 6 has a receiving function of receiving the print data (print job) from the host device 2 and a dividing function of dividing the received print data into the drawing data and the setting data. The setting data resulting from the division in the printing device 6 is processed in the setting-data processing unit 70. The user interface unit 77 includes a display device (for example, a liquid crystal panel) capable of displaying a variety of information, such as status information or function setting information of the printing device 6, and an input device (including operation buttons and numeric buttons) with which the information displayed in the display device is selected and/or an instruction to perform the printing is input. The user interface unit 77 may be a touch panel in which the display device is integrated with the input device.

The setting-data processing unit 70 includes a setting-data determiner-register 71, a data storage processor 72, a data extraction processor 73, a disabled-function print data generator 74, an enabled-function data updater 75, and a disabled-function display data generator 76. The setting-data determiner-register 71 determines the functions specified in the setting data to register any function which the printing device 6 does not have and functions which cannot coexist with each other in the disabled function data and to register the processable function in the enabled function data.

After the setting-data determiner-register 71 has completed the determination and the registration for all the functions in the setting data, the data storage processor 72 performs storage processing when the disabled function data has functions registered therein. Specifically, the data storage processor 72 stores the drawing data, extracted from the print data, and the enabled function data and the disabled function data, registered by the setting-data determiner-register 71, in a storage device (for example, a memory or a hard disk) in the printing device 6. The data storage processor 72 also creates identifications (unprocessable function ID's) used for identifying the locations where the above data is stored.

The disabled-function print data generator 74 generates disabled-function print data indicating to the user that the unprocessable function exists in the printing based on the disabled function data. The identifications created by the data storage processor 72 are also stored in the disabled-function print data. The print processing unit 21 prints the disabled-function print data to indicate the presence of the disabled function to the user by using the output on a sheet of paper. At this time, the drawing data stored by the data storage processor 72 is not printed.

The user who viewed a message indicating that the printing was not performed due to the presence of the disabled function to recognize the presence of the disabled function, inputs the identification identifying the stored print data with the user interface unit 77. The data extraction processor 73 extracts the disabled function data corresponding to the input identification. The disabled-function display data generator 76 generates disabled-function display data including information prompting the user to specify the processing for the disabled function based on the disabled function data extracted by the data extraction processor 73.

The setting-data processing unit 70 displays the information prompting the user to specify the processing for the disabled function in the user interface unit 77 based on the generated disabled-function display data. If the user performs appropriate processing, the enabled-function data updater 75 updates the enabled function data and the drawing-data processing unit 20 processes the drawing data based on the updated enabled function data. The processed drawing data is printed by the print processing unit 21 based on the updated enabled function data.

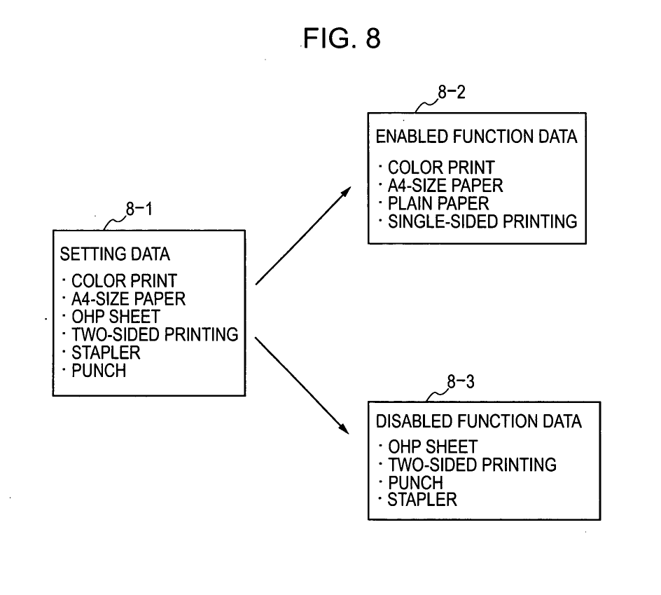

An example of the determination and registration of the setting data in the setting-data determiner-register 71 will now be described. FIG. 8 shows an example of the determination and registration of the setting data in the setting-data determiner-register 71. In other word, FIG. 8 shows an example indicating how the setting data is converted into the enabled function data and the disabled function data.

Referring to FIG. 8, reference numeral 8-1 denotes setting data having “Color print”, “A4-size paper”, “OHP sheet”, “Two-sided printing”, “Stapler”, and “Punch” set therein as the functions. Since the “Stapler” cannot coexist with the “Punch” and the “OHP sheet” cannot coexist with the “Two-sided printing” in the printing device 6, two conflicts occur. As described in the first embodiment, the combinations of the conflicting functions are not limited to the above ones.

The setting-data determiner-register 71 generates enabled function data 8-2 and disabled function data 8-3 shown in FIG. 8 based on the setting data 8-1. The conflicting functions “Stapler” and “Punch” and the conflicting functions “OHP sheet” and the “Two-sided printing” are registered in the disabled function data 8-3. The “Color print” and “A4-size paper” irrelevant to the conflict, “Plain paper” set as default paper, instead of the disabled “OHP sheet”, and “Single-sided printing” set as default printing, instead of the disabled “Two-sided printing”, are registered in the enabled function data 8-2. The process according to the second embodiment differs from the process for the setting data 3-1 in FIG. 3, according to the first embodiment, in that all the conflicting functions are registered in the disabled function data 8-3.

Since the enabled function data 8-2 and the disabled function data 8-3 are used only in the printing device 6, as similarly described in the first embodiment, any format may be used.

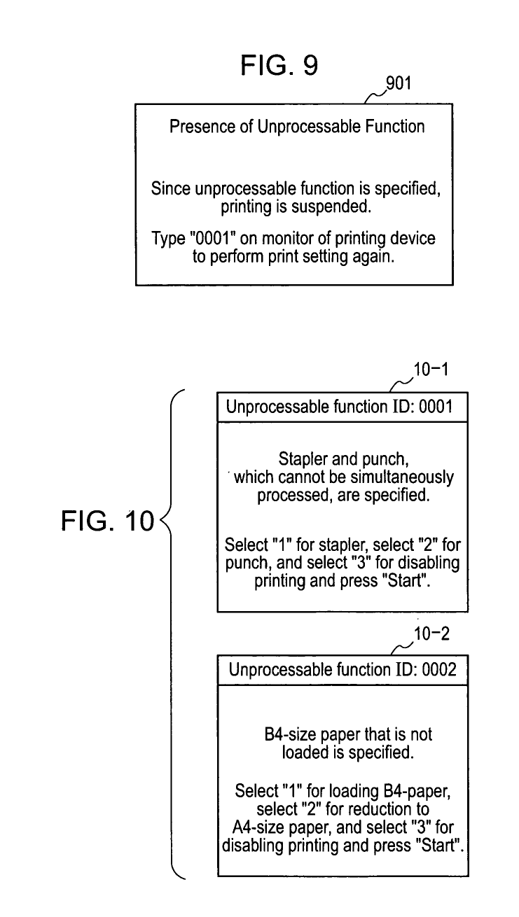

An example of a print result of the disabled-function print data, according to the second exemplary embodiment, when the disabled function exists will now be described. FIG. 9 shows an example of a print result of the disabled-function print data when the disabled function exists. As shown in FIG. 9, the identification created by the data storage processor 72 is described in the disabled-function print data. Inputting the described identification “0001” in the printing device 6 by user with the user interface unit 77 displays screens, shown in FIG. 10, prompting the user to perform the processing for the disabled function.

FIG. 10 shows examples of the disabled-function display data displayed in the user interface unit 77 when the identification of the disabled-function print data is input in the printing device 6. Referring to FIG. 10, reference numeral 10-1 denotes an example of the disabled-function display data displayed in the display device in the user interface unit 77 in the printing device 6 when the user inputs the identification (the unprocessable function ID) where the conflicting functions “Stapler” and “Punch” are set in the setting data. The user selects one numeric button to select the corresponding “Stapler”, “Punch”, or “Cancel printing”. Reference numeral 10-2 denotes an example of the disabled-function display data displayed in the display device in the user interface unit 77 when the paper having the specified size does not loaded. The user selects one numeric button to select loading of the paper having the specified size, reduction to the size already set for printing, or cancel of printing.

As described above, the printing device 6 according to the second exemplary embodiment presents to the user a selection screen in which any of the conflicting functions can be selected to prompt the user to set a desired function and to present a desired print result to the user.

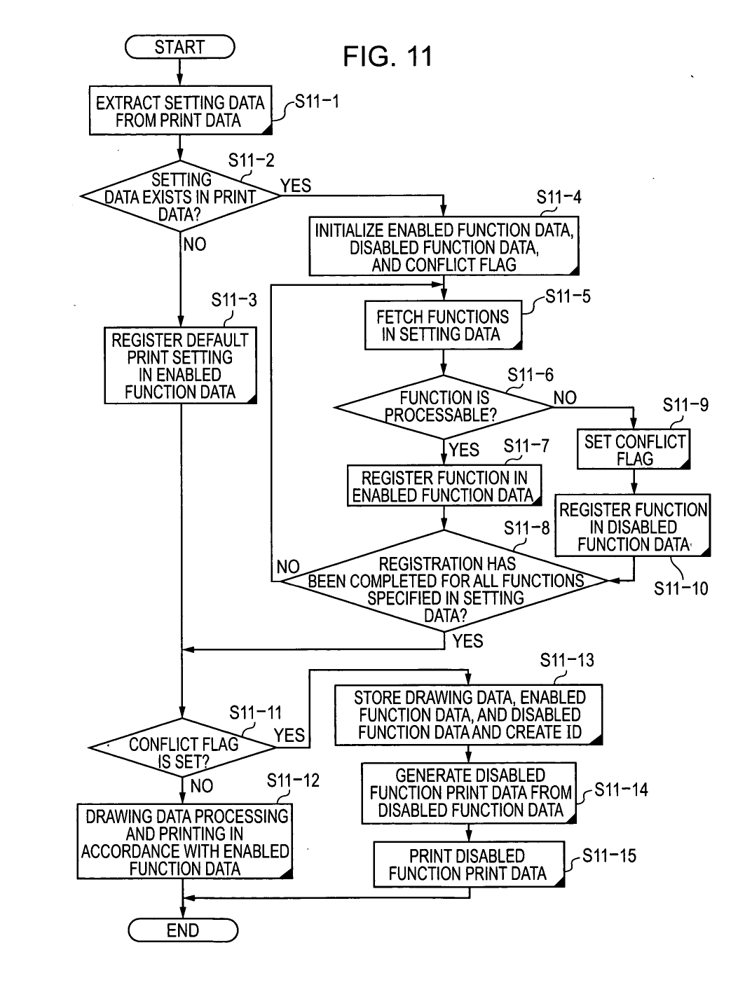

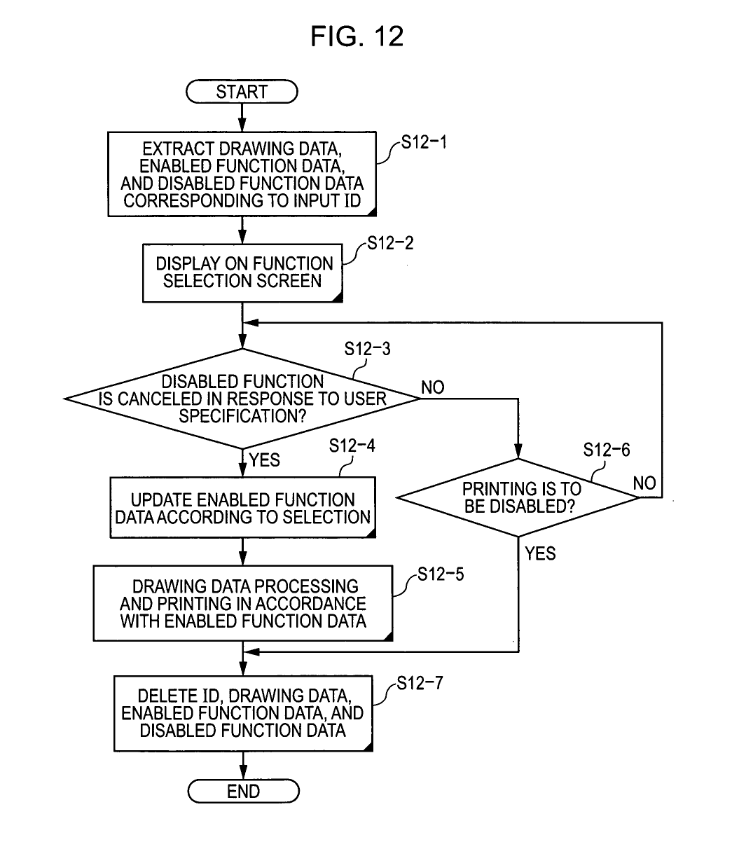

An exemplary setting data process in the printing device 6 shown in FIG. 7, according to the second exemplary embodiment, will now be described. FIGS. 11 and 12 are flowcharts showing an exemplary setting data process in the printing device 6 in FIG. 7, according to the second embodiment. FIG. 11 is a flowchart showing a process from a time when the printing device 6 receives the print data to a time when the printing device 6 outputs the disabled-function print data. FIG. 12 is a flowchart showing a process from a time when the user who has obtained the disabled-function print data sets the functions in the printing device 6 to a time when a final print is output.

The exemplary setting data process according to the second embodiment will now be described with reference to FIG. 11. After the print data is supplied from the host device 2 to the printing device 6, in Step S11-1, the setting-data processing unit 70 extracts the setting data from the received print data. In Step S11-2, the setting-data processing unit 70 determines whether the setting data exists in the print data (determines whether the setting data has been extracted).

If the setting data does not exist in the print data in the direct print (the determination is negative in Step S11-2), then in Step S11-3, the setting-data determiner-register 71 registers the default print setting in the enabled function data.

If the setting data exists in the print data (the determination is affirmative in Step S11-2), then in Step S11-4, the setting-data determiner-register 71 initializes the enabled function data, the disabled function data, and a conflict flag. The conflict flag is set when any disabled function exists.

In Step S11-5, the setting-data determiner-register 71 fetches each of the functions specified in the setting data. In Step S11-6, the setting-data determiner-register 71 determines whether the fetched function is processable in the printing device 6. If setting-data determiner-register 71 determines that the function is processable in the printing device 6 (the determination is affirmative in Step S11-6), then in Step S11-7, the setting-data determiner-register 71 registers the function in the enabled function data. If the setting-data determiner-register 71 determines that the function is not processable in the printing device 6 (the determination is negative in Step S11-6), then in Step S11-9, the setting-data determiner-register 71 sets a conflict flag indicating the disabled function exists. In Step S11-10, the setting-data determiner-register 71 registers the function in the disabled function data.

In Step S11-8, the setting-data determiner-register 71 determines whether the registration has been completed for all the functions specified in the setting data. If the setting-data determiner-register 71 determines that the registration has not been completed for all the functions in the setting data (the determination is negative in Step S11-8), the process goes back to Step S11-5. The steps from S11-5 to S11-7 or the steps S11-5, S11-6, S11-9, and S11-10 are repeated until all the functions specified in the setting data have been registered in the enabled function data or the disabled function data.

If the setting-data determiner-register 71 determines that the registration has been completed for all the functions specified in the setting data (the determination is affirmative in Step S11-8), then in Step 11-11, the setting-data processing unit 70 determines whether a conflict flag indicating the disabled function exists is set. Or, after the default print setting is registered in the enabled function data in Step S11-3 because the setting data does not exist, then in Step S11-11, the setting-data processing unit 70 determines whether a conflict flag indicating the disabled function exists is set. If the setting-data generation application 70 determines that a conflict flag is not set (the determination is negative in Step S11-11), then in Step S11-12, the drawing-data processing unit 20 processes the drawing data in accordance with the enabled function data and the print processing unit 21 performs the printing in accordance with the enabled function data and, then, the setting data process terminates.

If the setting-data processing unit 70 determines that a conflict flag is set (the determination is affirmative in Step S11-11), then in Step S11-13, the data storage processor 72 stores the drawing data, the enabled function data, and the disabled function data in the storage device in the printing device 6 and creates an identification indicating the information used for accessing the storage area. In Step S11-14, the disabled-function print data generator 74 generates disabled-function print data, as shown in FIG. 9, including the disabled function data and the identification. In Step S11-15, the print processing unit 21 performs the printing of the disabled-function print data generated by the disabled-function print data generator 74. When the print data including the setting data having a conflict is received, the conflicting functions are disabled and the disabled-function print data is output. Although the process in the printing device 6 terminates here, the process in FIG. 12 follows Step S11-15.

The process from a time when the user who has obtained the disabled-function print data sets the functions in the printing device 6 to a time when a final print is output, according to the second embodiment, will be described with reference to FIG. 12. First, the user inputs the identification (unprocessable function ID) described in the printed disabled-function print data, as shown in FIG. 4, with the user interface unit 77 in the printing device 6. In Step S12-1, the data extraction processor 73 extracts the drawing data, the enabled function data, and the disabled function data corresponding to the input identification from the storage device.

In Step S12-2, the disabled-function display data generator 76 generates disabled-function display data, as shown in FIG. 10, from the disabled function data and displays the generated disabled-function display data in the display device in the user interface unit 77. In Step S12-3, the process determines whether the user who viewed the disabled-function display data displayed in the display device selects a method of canceling the disabled function. If the user who viewed the disabled-function display data selects a method of canceling the disabled function (the determination is affirmative in Step S12-3), then in Step S12-4, the enabled-function data updater 75 adds a function corresponding to the selected method to update the enabled function data. In Step S12-5, the drawing-data processing unit 20 processes the drawing data in accordance with the updated enabled function data and the print processing unit 21 performs the printing in accordance with the updated enabled function data.

If the user does not select a method of canceling the disabled function (the determination is negative in Step S12-3), then in Step S12-6, the process determines whether the user selects an option of canceling (disabling) the printing, included in the options shown in FIG. 10. If the user selects the option of canceling (disabling) the printing (the determination is affirmative in Step S12-6), then in Step S12-7, the setting-data processing unit 70 deletes the drawing data, the enabled function data, the disabled function data, and the identification, which are stored in the storage device in the printing device 6. If the user does not select the option of canceling (disabling) the printing (the determination is negative in Step S12-6), the process goes back to Step S12-3, because the user does not select any of the options in FIG. 10, to wait for the user who selects an option. The setting-data processing unit 70 in the printing device 6 terminates the printing.

As described above, the printing device 6 according to the second exemplary embodiment stores the drawing data and the setting data, without performing the actual printing, and prints the print result, as shown in FIG. 9, indicating the presence of the disabled function, if a conflict occurs in the setting data (job ticket) in the direct print. Accordingly, the printing device 6 indicates an occurrence of the conflict to the user who viewed the print result and prompts the user to reset the function. When the user wants to reset the function, the printing device 6 receives the identification of the print job input with the user interface unit 77 and, then, displays options used for resolving the conflict occurring in the setting data of the print job identified by the identification. In other words, if a conflict occurs in the setting data (job ticket) in the direct print, the printing device 6 according to the second embodiment prompts the user to set a desired function in order to present a desired print result to the user. Hence, the user can obtain the desired print result without setting the function from the beginning and performing the printing again.

### Third Exemplary Embodiment

A third exemplary embodiment in the printing system having a similar architecture to that shown in FIG. 1 will now be described. More specifically, an example of the functional architecture of the printing system, including the host device 2 and the printing device 6, which printing system is capable of generating a program including a step for resolving the conflict, if a conflict occurs, transmitting the generated program to the host device 2 of a user, and prompting the user to reset the function in the host device 2, will now be described.

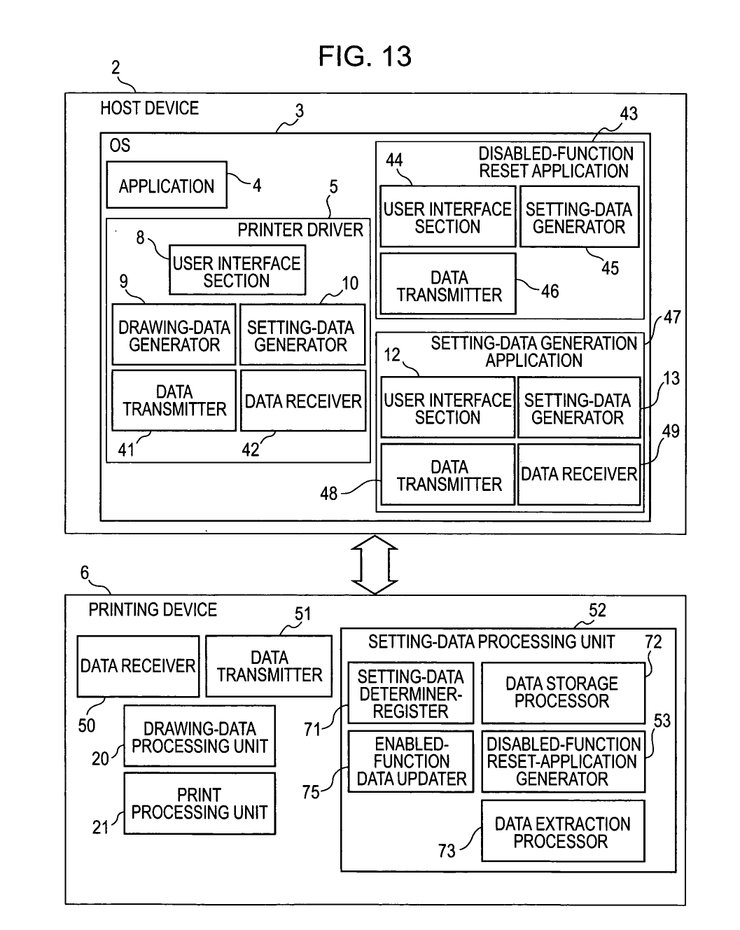

FIG. 13 shows an exemplary functional structure of the host device 2 and the printing device 6 shown in FIG. 1, according to an aspect of the third exemplary embodiment. The same reference numerals are used in the host device 2 and the printing device 6 in FIG. 13 to identify the same functional blocks in the host device 2 and the printing device 6 shown in FIG. 2. A description of these functional blocks is thus omitted.

Now referring to FIG. 13, the host device 2 according to the third embodiment includes an application 4, a printer driver 5, a disabled-function reset application 43, and a setting-data generation application 47, which run on an OS 3. The printer driver 5 includes a user interface section 8, a drawing-data generator 9, a setting-data generator 10, a data transmitter 41, and a data receiver 42. The data transmitter 41 transmits data, including print data, to the printing device 6. The data receiver 42 receives data, including a disabled-function reset application, from the printing device 6.

The disabled-function reset application 43 includes a user interface section 44, a setting data generator 45, and a data transmitter 46. The user interface section 44 displays a disabled-function reset screen described below. The setting data generator 45 generates setting data reflecting the resetting when the user of the host device 2 resets the functions based on the disabled-function reset screen. The data transmitter 46 transmits the setting data generated by the setting data generator 45 to the printing device 6.

The setting-data generation application 47 includes a user interface section 12, a setting-data generator 13, a data transmitter 48, and a data receiver 49. The data transmitter 48 transmits the print data including the setting data generated by the setting-data generator 13 to the printing device 6. The data receiver 49 receives the data, including the disabled-function reset application, in the direct print. The same reference numerals are used in the setting-data generation application 47 in FIG. 13 to identify the same functional blocks (the user interface section 12 and the setting-data generator 13) in the setting-data generation application 7 shown in FIG. 2. A description of these functional blocks is thus omitted.

As shown in FIG. 13, the printing device 6 according to the third embodiment includes a drawing-data processing unit 20, a print processing unit 21, a data receiver 50, a data transmitter 51, and a setting-data processing unit 52. The data receiver 50 receives the print data (print job) from the host device 2 and receives the setting data reset by the disabled-function reset application 43. The data transmitter 51 transmits a disabled-function reset application generated by the disabled-function reset-application generator 53 described below to the host device 2. The printing device 6 has, for example, a dividing function of dividing the print data received by the data receiver 50 into the drawing data and the setting data. The setting data resulting from the division of the print data is processed in the setting-data processing unit 52 in the printing device 6.

The setting-data processing unit 52 includes a setting-data determiner-register 71, a data storage processor 72, a data extraction processor 73, an enabled-function data updater 75, and a disabled-function reset-application generator 53. The disabled-function reset-application generator 53 generates the disabled-function reset application if a conflict occurs. The disabled-function reset application, which is an application program executable on the OS 3 in the host device 2, displays a disabled-function reset screen used for prompting the user of the host device 2 to reset the disabled function. The same reference numerals are used in the setting-data processing unit 52 in FIG. 13 to identify the same functional blocks (the setting-data determiner-register 71, the data storage processor 72, the data extraction processor 73, and the enabled-function data updater 75) in the setting-data processing unit 70 shown in FIG. 7. A description of these functional blocks is thus omitted.

As in the previous embodiments, the printing device 6 according to the third exemplary embodiment is capable of both the printing through the printer driver 5 and the printing directly receiving the data generated in the application 4 or the data generated in advance to print the received data, through no printer driver.

Generally, in the direct print, the setting-data generation application rarely recognizes all the functions of the printing device 6, unlike the printer driver 5 supplied with the printing device 6 for distribution. Accordingly, there are many cases where the generated setting data is not completely appropriate. An exemplary method of processing the setting data in the printing system according to the third embodiment is installed in the printing device 6 and the host device 2 as an example, and achieves a desired effect when the setting data including the function setting causing a conflict is supplied to the printing device 6.

When the print processing unit 21 in the printing device 6 receives the print data from the host device 2, the printing device 6 divides the received print data into the drawing data and the setting data and supplies the setting data to the setting-data processing unit 52. The setting-data determiner-register 71 in the setting-data processing unit 52 determines whether the functions specified in the setting data is processable, and registers each of the functions in the enabled function data or in the disabled function data in accordance with the determination result. More specifically, the setting-data determiner-register 71 registers the function which the printing device 6 does not have and the functions that cannot coexist with each other in the disabled function data and registers the function that is processable in the printing device 6 in the enabled function data. The processing in the setting-data determiner-register 71 is repeated until the registration has been completed for the all the functions in the setting data.

After the setting-data determiner-register 71 has completed the determination and registration of all the functions in the setting data, the drawing-data processing unit 20 processes the drawing data in accordance with the enabled function data and the print processing unit 21 performs the printing in accordance with the enabled function data when no function is registered in the disabled function data.

When any function is registered in the disabled function data, the data storage processor 72 stores the drawing data extracted from the print data and the enabled function data registered by the setting-data determiner-register 71 in a storage device (for example, a memory or a hard disk) in the printing device 6. The disabled-function reset-application generator 53 generates the disabled-function reset application, which is a program for displaying in the host device 2 the information indicating that the unprocessable function exists in the printing and the disabled-function reset screen including means for resetting the unprocessable function. Then, the data transmitter 51 transmits the disabled-function reset application generated by the disabled-function reset-application generator 53 to the host device 2.

When the print data received by the data receiver 50 is transmitted from the data transmitter 41 in the printer driver 5 (not in the direct print), the data transmitter 51 transmits the disabled-function reset application to the data receiver 42 in the printer driver 5. In contrast, when the print data received by the data receiver 50 is transmitted from the data transmitter 48 in the setting-data generation application 47 (in the direct print), the data transmitter 51 transmits the disabled-function reset application to the data receiver 49 in the setting-data generation application 47. Invoking the disabled-function reset application received by the data receiver 42 or the data receiver 49 installs the disabled-function reset application 43 in the OS 3 in the host device 2, as shown in FIG. 13.

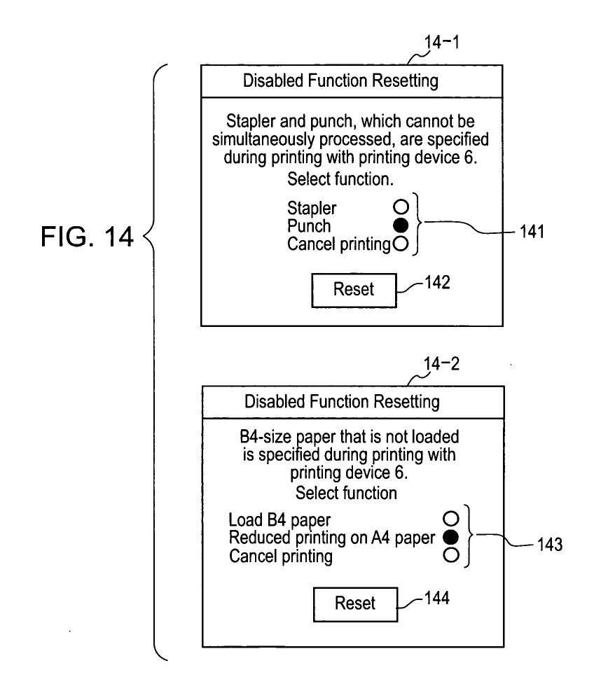

After being invoked, the disabled-function reset application 43 displays, for example, disabled-function reset screens 14-1 and/or 14-2 (as shown in FIG. 14) in a display device in the host device 2 through the processing in the user interface section 44. The exemplary disabled function reset screens 14-1 and 14-2 shown in FIG. 14 will be described in detail later in the specification. Next, the user of the host device 2 may reset the disabled functions on the disabled-function reset screens 14-1 and 14-2. The setting data generator 45 generates the setting data according to the resetting in response to the resetting by the user. The data transmitter 46 transmits the setting data generated by the setting data generator 45 to the printing device 6.

The data receiver 50 in printing device 6 receives the setting data according to the resetting, generated by the disabled-function reset application 43. The data extraction processor 73 extracts the drawing data and the enabled function data in accordance with the setting data received by the data receiver 50 from the storage device. The enabled-function data updater 75 updates the enabled function data based on the setting data having no disabled function, generated by the disabled-function reset application 43. The printing device 6 processes the drawing data extracted by the data extraction processor 73 by using the drawing-data processing unit 20 based on the updated enabled function data and performs the printing by using the print processing unit 21.

Since examples of the setting data processed by the setting-data determiner-register 71 in the printing device 6 and examples of the enabled function data and the disabled function data generated by processing the setting data, according to the third embodiment, are similar to the ones shown in FIG. 8 according to the second embodiment, a description is thus omitted.

Examples of the disabled-function reset screens in which the disabled-function reset application 43 displays in the display device in the host device 2 through the processing in the user interface section 44, according to the third embodiment, will now be described. Referring to FIG. 14, a disabled-function reset screen 14-1 is a screen example which may be used by the user for resetting the disabled function when, for instance, the conflicting “Stapler” and “Punch” are specified. In the disabled-function reset screen 14-1, the user selects any of three selection buttons 141 “Stapler”, “Punch”, or “Cancel printing” and presses a reset button 142 to reset the functions or to cancel the printing. In other words, pressing the reset button 142 transmits the setting data reflecting a desired function setting to the printing device 6. The printing device 6 outputs the print result based on the setting data having the desired function setting.

A disabled-function reset screen 14-2 is a screen example used by the user for resetting the disabled function when the paper having the specified size is not loaded. In the disabled-function reset screen 14-2, the user selects any of three selection buttons 143 “Load B4 paper”, “Reduced printing on A4 paper”, or “Cancel printing” and presses a reset button 144 to reset the functions or to cancel the printing. In other words, pressing the reset button 144 transmits the setting data reflecting a desired function setting to the printing device 6. The printing device 6 outputs the print result based on the setting data having the desired function setting.

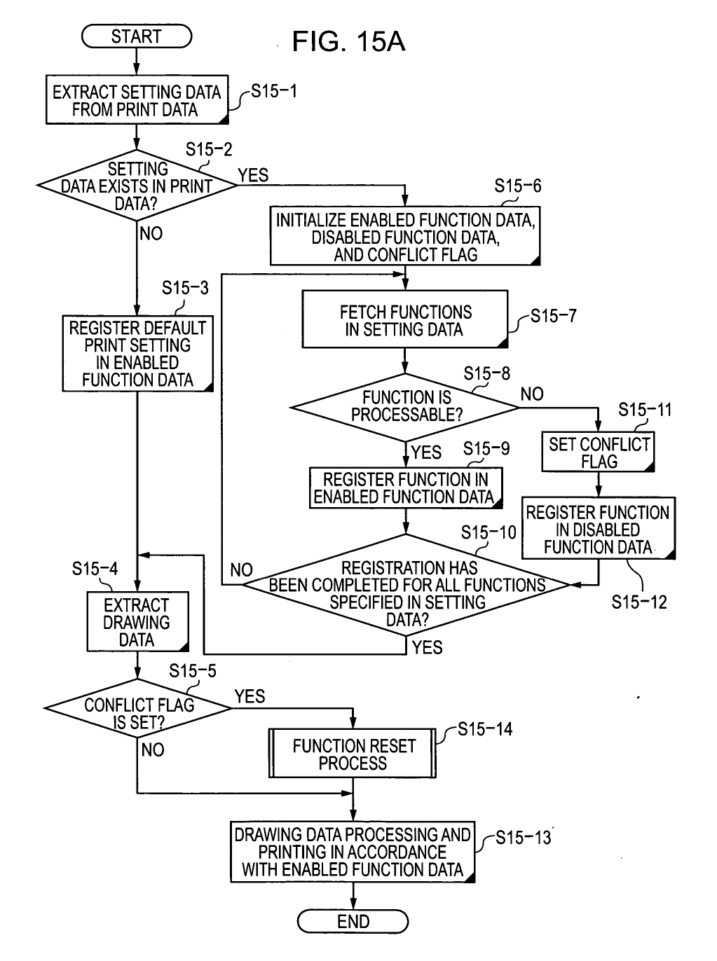

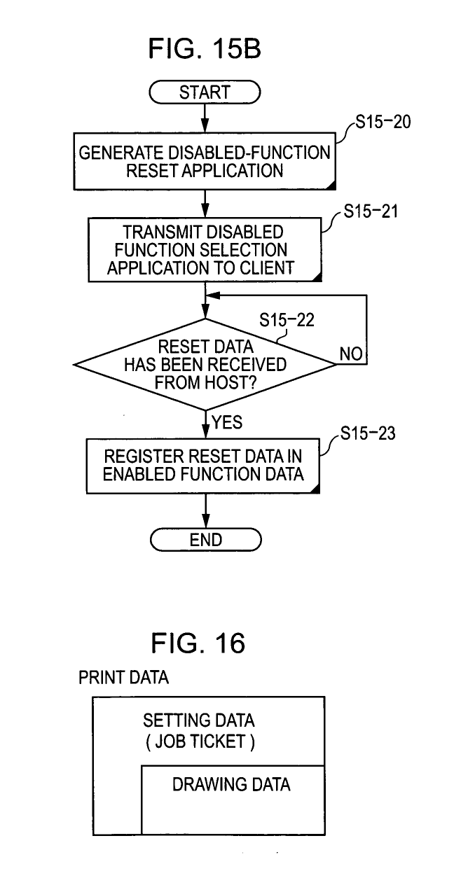

An exemplary setting data process in the printing system including the host device 2 and the printing device 6 shown in FIG. 13 will now be described. FIG. 15A is a flowchart showing an exemplary setting data process in the printing system including the host device 2 and the printing device 6 shown in FIG. 13. The method of processing the setting data according to the third embodiment will be described with reference to FIG. 15A.

After the print data is supplied from the host device 2 to the printing device 6, in Step S15-1, the setting-data processing unit 52 extracts the setting data from the print data. In Step S15-2, the setting-data processing unit 52 determines whether the setting data exists in the print data. If the setting data does not exist in the print data in the direct print (the determination is negative in Step S15-2), then in Step S15-3, the setting-data processing unit 52 registers the default print setting in the enabled function data.

If the setting data exists in the print data (the determination is affirmative in Step S15-2), then in Step S15-6, the setting-data processing unit 52 initializes the enabled function data, the disabled function data, and a conflict flag. The conflict flag is set when any disabled function exists.

In Step S15-7, the setting-data determiner-register 71 fetches each of the functions specified in the setting data. In Step S15-8, the setting-data determiner-register 71 determines whether the fetched function is processable in the printing device 6. If the setting-data determiner-register 71 determines that the function is processable in the printing device 6 (the determination is affirmative in Step S15-8), then in Step S15-9, the setting-data determiner-register 71 registers the function in the enabled function data. If the setting-data determiner-register 71 determines that the function is not processable in the printing device 6 (the determination is negative in Step S15-8), then in Step S5-11, the setting-data determiner-register 71 sets a conflict flag indicating the disabled function exists. In Step S15-12, the setting-data determiner-register 71 registers the function in the disabled function data. In Step S15-10, the setting-data determiner-register 71 determines whether the registration has been completed for all the functions specified in the setting data. If the setting-data determiner-register 71 determines that the registration has not been completed for all the functions in the setting data (the determination is negative in Step S15-10), the process goes back to Step S15-7. The setting-data determiner-register 71 repeats the steps from S15-7 to S15-9 or the steps S15-7, S15-8, S15-11, and S15-12 until all the functions specified in the setting data have been registered in the enabled function data or the disabled function data.

If the setting-data determiner-register 71 determines that the registration has been completed for all the functions specified in the setting data (the determination is affirmative in Step S15-10), then in Step S15-4, the drawing-data processing unit 20 extracts the drawing data from the print data. Or, after the default print setting is registered in the enabled function data in Step S15-3 because the setting data does not exist, then in Step S15-4, the drawing-data processing unit 20 extracts the drawing data from the print data.

In Step S15-5, the setting-data processing unit 52 determines whether the conflict flag indicating the disabled function exists is set. If the setting-data processing unit 52 determines that the conflict flag is not set, then in Step S15-13, the drawing-data processing unit 20 processes the drawing data in accordance with the enabled function data and the print processing unit 21 performs the printing in accordance with the enabled function data and, then, the setting data process terminates. If the setting-data processing unit 52 determines that the conflict flag is set, then in Step S15-14, the printing device 6 performs a function reset process to update the enabled function data in the printing device 6 so as not to include the disabled function and a conflict. In Step S15-13, the drawing-data processing unit 20 processes the drawing data in accordance with the updated enabled function data and the print processing unit 21 performs the printing in accordance with the updated enabled function data and, then, the setting data process terminates. The function reset process in Step S15-14 will be described in detail with reference to FIG. 15B.

FIG. 15B is a flowchart showing in detail an exemplary function reset process in Step S15-14 from FIG. 15A. If the conflict flag indicating the disabled function exists is set in Step S15-5, then in Step S15-20, the disabled-function reset-application generator 53 generates a disabled-function reset application running on the OS 3 in the host device 2. The disabled-function reset application is a program for prompting the user to reset the disabled function based on the disabled function data. In Step S15-21, the data transmitter 51 transmits the disabled-function reset application generated by the disabled-function reset-application generator 53 to the host device 2.

In the host device 2, the disabled-function reset application 43 is invoked to display, for example, the disabled-function reset screens 14-1 and/or 14-2 shown in FIG. 14. When the user resets the functions on the disabled-function reset screens 14-1 and/or 14-2, the data transmitter 46 transmits the setting data reflecting the resetting to the printing device 6.

While the disabled-function reset application is invoked in the host device 2 and the user resets the function, the printing device 6 waits for the setting data reflecting the resetting, to be transmitted from the host device 2 again. In Step S15-22, the process determines whether the setting data reflecting the resetting. If the data receiver 50 receives the setting data reflecting the resetting by the user from the host device 2 (the determination is affirmative in Step S15-22), then in Step S15-23, the enabled-function data updater 75 registers the setting data in the enabled function data and, then, the function reset process in Step S15-14 in FIG. 15A terminates.

As described above, in the printing system according to the third exemplary embodiment, if a conflict occurs in the job ticket (setting data) in the direct print, the printing device 6 transmits the application (disabled-function reset application) including the step for resolving the conflict to the host device 2. The host device 2 invokes the received application, prompts the user to reset the disabled function, and transmits the setting data reflecting the resetting to the printing device 6. The printing device 6 updates the enabled function data based on the setting data reflecting the resetting and performs the printing based on the updated enabled function data. With such a printing system, the disabled function can be reset to a desired function setting to perform the printing even if a conflict occurs. Accordingly, the printing system can avoid unnecessary printing and can easily provide a desirable print result.

### Other Exemplary Embodiments

The reset setting data or the information indicating that the printing is canceled is transmitted from the host device 2 to the printing device 6 in the above third embodiment. According to another embodiment, if the reset setting data is not returned from the host device 2 to the printing device 6 within a predetermined time after the disabled-function reset application is transmitted from the printing device 6 to the host device 2, the processable functions in the functions registered in the disabled function data are registered in the enabled function data in order of priority, and the processing of the drawing data and the printing are performed based on the updated enabled function data. In addition, when the print job includes information (for example, an e-mail address) concerning the contact address of the owner of the print job, the printing system may further include a notification unit notifying the contact address of the information concerning the processing of a conflict.

According to the above embodiments, the processing units in the host devices 2 and the printing devices 6 shown in FIGS. 2, 7, and 13 read out programs for realizing the functions of the processing units from the memories and the central processing units (CPU's) execute the programs to realize the functions. In other words, the host device 2 and the printing device 6 each include at least the CPU and the memory in the hardware structure. The memory is a computer-readable recording medium, such as a hard disk drive (HDD). The user interface units or sections in the host device 2 and the printing device 6 include the hardware, such as the display device and the input device. The print processing unit 21 in the printing device 6 includes the hardware, including the printing device printing images on a print medium, such as sheets of paper, and the downstream processing device sorting and/or stapling the print medium on which the images are printed.

It is noted and acknowledged that the printing system is not limited to the above structure and all or part of the functions of the processing units in the host devices 2 and the printing devices 6 shown in FIGS. 2, 7, and 13 may be performed by dedicated hardware. Moreover, the above memory is not limited to the HDD and may be a nonvolatile memory, such as a magneto-optical device or a flash memory, a read-only recording medium, such as a compact disk read only memory (CD-ROM), or a volatile memory excluding a random access memory (RAM). Alternatively, the memory may be a computer-readable-writable recording medium having any combination of the above media.

It is further noted that the programs for realizing the functions of the host devices 2 and the printing devices 6 shown in FIGS. 2, 7, and 13 may be recorded on computer-readable recording media, and computer systems may read out and execute the programs recorded on the recording media to perform the processing. More specifically, after the programs read out from the storage medium have been written in the memory that is provided in an expansion board included in the computer or in an expansion unit connected to the computer, the CPU or the like in the expansion board or the expansion unit may execute all or part of the actual processing based on instructions in the program to realize the functions of the embodiments described above.

It is also noted that the “computer-readable recording media” may be, but is not limited to, portable media, such as flexible disks, magneto-optical disks, ROMs, or CD-ROMs, or storage devices, such as hard disks, included in the computer systems. Furthermore, the “computer-readable recording media” may be, for example, volatile memories (RAMs) storing the programs for a predetermined time, in the computer systems serving as the servers or the clients when the programs are transmitted over networks, such as the Internet, or over communication lines, such as telephone lines.

Furthermore, the above programs may be transmitted from computer systems having the programs stored in the storage devices to other computer systems via transmission media or through the transmitted waves in the transmission media. The “transmission media” transmitting the programs are media having a function of transmitting the information, including the networks (communication networks) such as the Internet or the communication lines such as the telephone lines. In addition, the above programs may realize part of the functions described above or may be difference files (difference programs) capable of realizing the above functions in combination with the programs already recorded in the computer systems.

Moreover, a program product, such as a computer-readable recording medium having the above programs recorded thereon, is also considered an embodiment of the present invention. Therefore, the present invention is applicable to programs, recording mediums, transmission mediums, and program products which implement the aforementioned embodiments of the present invention.

Although the embodiments of the present invention are described in detail with reference to the attached drawings, the specific architectures are not limited to the embodiments and various changes and modifications may be made to the invention without departing from the spirit and scope thereof.

As described above, and according to the embodiments of the present invention, it is possible to perform appropriate and user-friendly processing for unprocessable settings, such as conflicts, in the direct print.

And according to another aspect of the present invention, an image forming apparatus having multiple functions in an image forming process includes a receiving unit of receiving print data including first setting data, which is information concerning function settings, and drawing data; a disabled-function determining unit of determining the presence of a disabled function based on the first setting data in the print data received by the receiving unit; a resetting unit of resetting the first setting data to a predetermined function in accordance with the disabled function to generate second setting data when the disabled-function determining unit determines that the disabled function exists; and an image forming unit of performing the image forming process on an output medium based on the second setting data generated by the resetting unit and the drawing data.

With this architecture, if a conflict occurs in the direct print, the image forming apparatus determines in the disabled-function determining unit that the disabled function exists and the image forming apparatus resets the first setting data to the predetermined function which most users probably expect to generate the second setting data in order to output the drawing data. In other words, it is possible to perform appropriate processing for the unprocessable settings, such as the conflicts, in the direct print.

According to yet another embodiment of the present invention, the image forming apparatus further includes an output unit of outputting information concerning the resetting in the resetting unit. With this embodiment, it is possible to present which function is disabled in the resetting in the resetting unit.

According to still yet another embodiment of the present invention, an image forming apparatus having multiple functions in an image forming process includes a receiving unit of receiving print data including first setting data, which is information concerning function settings, and drawing data; a disabled-function determining unit of determining the presence of a disabled function based on the first setting data in the print data received by the receiving unit; and an output unit of outputting at least one of resetting information indicating an appropriate function reset for the disabled function, information concerning the print data, and information concerning the client of the print data, and disabled function information concerning the disabled function, when the disabled-function determining unit determines that the disabled function exists.

With this embodiment, if a conflict occurs in the direct print, it is possible to output the information concerning the disabled function and to present the information to the user, regardless of whether the printing is performed.

According to another embodiment of the image forming apparatus, the image forming apparatus further includes a data storage unit of temporarily storing the drawing data, the first setting data, and the disabled function information and an image forming unit of performing the image forming process on an output medium based on second setting data, which is generated based on the first setting data stored in the data storage unit and which does not include the disabled function, and the drawing data stored in the data storage unit.

With this architecture, if a conflict occurs in the direct print, it is possible to store the drawing data and the setting data without performing the printing and, then, to output the information concerning the disabled function. Accordingly, for example, when the user referred to the information concerning the disabled function to reset the function and obtained the second setting data reflecting the resetting, it is possible to output the data on the output medium based on the second setting data and the drawing data stored in the data storage unit. In other words, the output in accordance with the second setting data reflecting the user's request can be provided.

According to another embodiment of the image forming apparatus, when the print data is transmitted from the user's terminal over a network, the image forming apparatus further includes a generating unit of generating a reset program for displaying a reset screen prompting the user to reset the disabled function in the first setting data on the user's terminal and a transmitting unit of transmitting the reset program generated by the generating unit to the user's terminal, for providing the second setting data which is generated based on the first setting data stored in the data storage unit and which does not include the disabled function.

With this architecture, if a conflict occurs in the direct print, it is possible to invoke the reset program for resolving the conflict in the user's terminal to prompt the user to reset the disabled function.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-300550 filed Oct. 14, 2004, which is hereby incorporated by reference herein in its entirety.

What is claimed is:

1. A printing apparatus comprising:
a receiving unit configured to receive print data including setting data;
a determining unit configured to determine whether a conflict of functions occurs in the setting data received by the receiving unit; and
an output unit configured to output a disabled function and directions for enabling the disabled function if the determining unit determines that a conflict of the functions occurs in the setting data.

2. The printing apparatus according to claim 1,
wherein the output unit outputs the disabled function, the directions for enabling the disabled function, and an image based on the print data received by the receiving unit if the determining unit determines that a conflict of the functions occurs in the setting data.

3. The printing apparatus according to claim 2,
wherein the output unit includes a print unit.

4. The printing apparatus according to claim 1, further comprising a print unit configured to perform printing based on the print data received by the receiving unit in accordance with a print instruction.

5. The printing apparatus according to claim 1, further comprising a print unit configured to perform printing based on the print data received by the receiving unit if the determining unit determines that no conflict of the functions occurs in the setting data.

6. The printing apparatus according to claim 1,
wherein the determining unit extracts data in order of priority from the setting data received by the receiving unit, compares the extracted data with enabled data, and registers the data in the enabled data if no conflict of the functions occurs and registers the data in disabled data if a conflict of the functions occurs in the determination of a conflict of the functions.

7. A printing apparatus comprising:
a receiving unit configured to receive print data including setting data;
a determining unit configured to determine whether a conflict of functions occurs in the setting data received by the receiving unit; and
a reset unit configured to reset the setting data if the determining unit determines that a conflict of the functions occurs in the setting data.

8. The printing apparatus according to claim 7,
wherein the reset unit transmits a function reset application to a host and receives reset data from the host in order to reset the setting data.

9. The printing apparatus according to claim 7,
wherein the determining unit extracts data in order of priority from the setting data received by the receiving unit, compares the extracted data with enabled data, and registers the data in the enabled data if no conflict of the functions occurs and registers the data in disabled data if a conflict of the functions occurs in the determination of a conflict of the functions.

10. The printing apparatus according to claim 8,
wherein the reset unit registers the reset data in enabled data when the reset unit receives the reset data from the host.

11. A method of setting functions in a printing apparatus, the method comprising the steps of:
receiving print data including setting data;
determining whether a conflict of functions occurs in the setting data received in the receiving step; and
outputting a disabled function and directions for enabling the disabled function if it is determined that a conflict of the functions occurs in the setting data.

12. The method of setting functions in the printing apparatus, according to claim 11,
wherein the disabled function, the directions for enabling the disabled function, and an image based on the print data received in the receiving step are output in the outputting step if it is determined that a conflict of the functions occurs in the setting data.

13. The method of setting functions in the printing apparatus, according to claim 12,
wherein the outputting step includes a print step.

14. The method of setting functions in the printing apparatus, according to claim 11, further comprising a step of performing printing based on the print data received in the receiving step in accordance with a print instruction.

15. The method of setting functions in the printing apparatus, according to claim 11, further comprising a step of performing printing based on the print data received in the receiving step if it is determined that no conflict of the functions occurs in the setting data.

16. The method of setting functions in the printing apparatus, according to claim 11,
wherein, in the determination of a conflict of the functions, data is extracted in order of priority from the setting data received in the receiving step, the extracted data is compared with enabled data, and the data is registered in the enabled data if no conflict of the functions occurs and the data is registered in disabled data if a conflict of the functions occurs.

17. A method of setting functions in a printing apparatus, the method comprising the steps of:
receiving print data including setting data;
determining whether a conflict of functions occurs in the setting data received in the receiving step; and
resetting the setting data if it is determined that a conflict of the functions occurs in the setting data.

18. The method of setting functions in the printing apparatus, according to claim 17,
wherein, in the resetting step, a function reset application is transmitted to a host and reset data is received from the host in order to reset the setting data.

19. The method of setting functions in the printing apparatus, according to claim 17,
wherein, in the determination of a conflict of the functions, data is extracted in order of priority from the setting data received in the receiving step, the extracted data is compared with enabled data, and the data is registered in the enabled data if no conflict of the functions occurs and the data is registered in disabled data if a conflict of the functions occurs.

20. The method of setting functions in the printing apparatus, according to claim 18,
wherein the reset data is registered in enabled data when the reset data is received from the host in the resetting step.

21. A program executed in a computer, the program comprising the steps of:
receiving print data including setting data;
determining whether a conflict of functions occurs in the setting data received in the receiving step; and
outputting a disabled function and directions for enabling the disabled function if it is determined that a conflict of the functions occurs in the setting data.

22. The program executed in the computer, according to claim 21,
wherein the disabled function, the directions for enabling the disabled function, and an image based on the print data received in the receiving step are output in the outputting step if it is determined that a conflict of the functions occurs in the setting data.

23. The program executed in the computer, according to claim 22,
wherein the outputting step includes a print step.

24. The program executed in the computer, according to claim 21, further comprising a step of performing printing based on the print data received in the receiving step in accordance with a print instruction.

25. The program executed in the computer, according to claim 21, further comprising a step of performing printing based on the print data received in the receiving step if it is determined that no conflict of the functions occurs in the setting data.

26. The program executed in the computer, according to claim 21,
wherein, in the determination of a conflict of the functions, data is extracted in order of priority from the setting data received in the receiving step, the extracted data is compared with enabled data, and the data is registered in the enabled data if no conflict of the functions occurs and the data is registered in disabled data if a conflict of the functions occurs.

27. A program executed in a computer, the program comprising the steps of:
receiving print data including setting data;
determining whether a conflict of functions occurs in the setting data received in the receiving step; and
resetting the setting data if it is determined that a conflict of the functions occurs in the setting data.

28. The program executed in the computer, according to claim 27,
wherein, in the resetting step, a function reset application is transmitted to a host and reset data is received from the host in order to reset the setting data.

29. The program executed in the computer, according to claim 27,
wherein, in the determination of a conflict of the functions, data is extracted in order of priority from the setting data received in the receiving step, the extracted data is compared with enabled data, and the data is registered in the enabled data if no conflict of the functions occurs and the data is registered in disabled data if a conflict of the functions occurs.

30. The program executed in the computer, according to claim 28,
wherein the reset data is registered in enabled data when the reset data is received from the host in the resetting step.
